(19) United States
(12) Patent Application Publication
(10) Pub. No.: US 2025/0020517 A1
(43) Pub. Date: Jan. 16, 2025

(54) MEASURING TEMPERATURE OF AN ELECTROLYTIC BATH

(71) Applicant: ELYSIS LIMITED PARTNERSHIP, Montreal (CA)

(72) Inventors: Leroy D'ASTOLFO, Lower Burrell, PA (US); David PRINCE, Murrysville, PA (US); Rajneesh CHAUDHARY, Export, PA (US); Nick FINDLEY, Sewickley, PA (US)

(73) Assignee: ELYSIS LIMITED PARTNERSHIP, Montreal (CA)

(21) Appl. No.: 18/899,037

(22) Filed: Sep. 27, 2024

Related U.S. Application Data
(63) Continuation of application No. PCT/CA2023/050460, filed on Apr. 5, 2023.
(60) Provisional application No. 63/328,111, filed on Apr. 6, 2022.

(51) Int. Cl. G01K 1/10; C25C 1/02; C25C 7/06

(52) U.S. Cl. CPC G01K 1/105; C25C 1/02; C25C 7/06

(57) ABSTRACT

It is disclosed an apparatus and method for determining a temperature of the bath of an electrolytic cell during electrolytic production of a metal. The apparatus comprising an electrode body and a conductor pin at least partially inserted thereinto for providing electrical connection; and a probe inserted into the conductor pin, for providing one or more probe readings and being operable when positioned at least partially below a bath-vapor interface upon immersion in the electrolytic bath. The temperature of the bath is determined based on at least one of the one or more probe readings. The probe is protected from corrosion by the conductor pin during metal production. The electrolytic 10 cell may comprise more than one apparatus for measuring temperature in order to evaluate a temperature profile in the bath. Preferably, the one or more anodes are inert or oxygen evolving anodes, and the metal to be produced is aluminum.

### CROSS-REFERENCE TO RELATED APPLICATIONS

The present application is a continuation of the international application no. PCT/CA2023/050460 filed on Apr. 5, 2023, the content of which is incorporated herewith by reference, which claims priority of U.S. provisional application No. 63/328,111 filed on Apr. 6, 2022, the content of which is also incorporated herewith by reference.

### FIELD

The present invention generally relates to an apparatus and a method for determining a temperature of an electrolytic bath, to be used inside an electrolytic cell, for instance for the production of a metal, such as aluminum.

### BACKGROUND

Aluminum metal, also called aluminium, is produced by electrolysis of

alumina, also known as aluminium oxide (IUPAC), in an electrolytic bath of molten electrolyte at about 750-1000° C. contained in a number of electrolytic cells. The cells have a crucible made of a refractory material capable of containing the electrolyte, at least one cathode and at least one anode. The electrolysis current that circulates in the electrolyte through the anodes and cathodes causes alumina reduction reactions and is also capable of maintaining the electrolyte bath at the target operating temperature by the Joule effect. The electrolysis cell is regularly supplied with alumina so as to compensate for consumption of alumina caused by electrolysis reactions.

The current method for measuring the temperature of the electrolytic bath is by immersing a thermocouple within a ceramic protection tube into the electrolytic bath at a depth of at least 2 inches below the bath-vapor interface (i.e., the bath surface). In this method, the thermocouple gets corroded rapidly and fails after 7 to 10 days of immersion in the electrolytic bath and therefore should be replaced oftentimes. Replacement of the thermocouple adds significant expenses related to the thermocouple, the ceramic protection, and the expenses of the replacement itself. There are also process disadvantages. For instance, each thermocouple is accurate to +/−3 or 4 degrees Celsius (° C.), so the process control can be disrupted by the replacement of the thermocouple that disagrees with the previous one by up to 4° C. Another issue is potential contamination of the bath by corrosion of the tubes. Moreover, in order to extend the lifetime of the thermocouples to 10 days, the ceramic tubes protecting the thermocouples are bulky and thick which makes them a non-trivial heat sink and further causing potential inaccuracy of their temperature measurement.

There is thus a need for a new apparatus and related methods for measuring or determining the temperature of the electrolytic bath of an electrolytic cell.

### SUMMARY

The shortcomings of the prior art are generally mitigated by a new system and method for pre-heating an electrolytic cell typically used for the electrolytic production of aluminum.

According to a first aspect, the invention is directed to an apparatus for determining a temperature of an electrolytic bath of an electrolytic cell during electrolytic production of a metal, the apparatus comprising: an electrode body; a conductor pin at least partially inserted in the electrode body for providing electrical connection to the electrode body; and a probe configured to be inserted in the conductor pin and to measure an inner temperature of the conductor pin, the probe providing one or more probe readings and being operable when positioned at least partially below a bath-vapor interface upon immersion of the electrode body in the electrolytic bath. The temperature of the electrolytic bath is thus determined based on at least one of the one or more probe readings. The probe is protected from corrosion by at least the conductor pin during the electrolytic production of the metal.

According to a second aspect, the invention is first directed to an apparatus for determining a temperature of an electrolytic bath of an electrolytic cell during electrolytic production of a metal, the apparatus comprising: one or more electrodes, each comprising an electrode body and a conductor pin at least partially inserted thereinto, the conductor pin providing electrical connection of the electrode; and at least one probe inserted into at least a corresponding one of the one or more conductor pins, each probe providing one or more probe readings and being operable when positioned at least partially below a bath-vapor interface upon immersion of the one or more electrodes into the electrolytic bath; wherein the temperature of the electrolytic bath is determined based on at least one of the one or more probe readings; and wherein the at least one probe is protected from corrosion by the corresponding one conductor pin during the electrolytic production of the metal.

According to a preferred embodiment, one and only one of each of the at least one probe is inserted into the at least one corresponding conductor pin.

According to a preferred embodiment, the one or more probe is configured to read a temperature inside of the corresponding conductor pin.

According to a preferred embodiment, each of the conductor pins is inserted into a corresponding one of the electrode bodies through an inner hole extending thereinside.

According to a preferred embodiment, the at least one probe is inserted into the at least one corresponding conductor pin through a bore extending thereinside. Preferably, the apparatus as disclosed herein further comprises a gap formed between the conductor pin and the electrode body, the gap containing a conductive material.

According to a preferred embodiment, the at least one probe is a thermocouple.

According to a preferred embodiment, the one or more electrodes are inert

or oxygen evolving anodes.

According to a preferred embodiment, the metal to be produced is aluminum.

According to another aspect, the invention is directed to a method for determining a temperature of an electrolytic bath of an electrolytic cell during electrolytic production of a metal, the electrolytic cell comprising an electrolytic bath and at least two electrodes, the method comprising:
immersing the at least two electrodes into the electrolytic bath, wherein at least one of the at least two electrodes is an apparatus for determining the temperature of the electrolytic bath comprising:
   an electrode body,
   a conductor pin at least partially inserted thereinto for providing electrical connection to the electrode body, and
   a probe inserted in the conductor pin, the probe being configured for providing one or more probe readings of an inner temperature of the conductor pin, wherein at least a portion of the probe is positioned below a bath-vapor interface;
receiving the one or more probe readings from the probe; and
determining the temperature of the electrolytic bath based on the one or more probe readings during the electrolytic production of the metal; the probe being protected from corrosion by at least the conductor pin during electrolytic production of the metal.

According to a preferred embodiment, the electrolytic cell comprises a plurality of electrodes among which more than one electrode is an apparatus for determining the temperature of the electrolytic bath, the method comprising receiving one or more probe readings from each of the apparatuses for determining the bath temperature.

According to another aspect, the invention is yet further directed to a method for determining a temperature of an electrolytic bath of an electrolytic cell during electrolytic production of a metal, the electrolytic cell comprising an electrolytic bath and at least two electrodes, the method comprising:
immersing the at least two electrodes into the electrolytic bath, wherein at least one of the at least two electrodes comprises an electrode body, a conductor pin at least partially inserted thereinto for providing electrical connection of the electrode, and at least one probe inserted into the conductor pin, each probe providing one or more probe readings, wherein at least a portion of the at least one probe is positioned below a bath-vapor interface;
receiving the one or more probe readings from the at least one probe; and
determining the temperature of the electrolytic bath based on the one or more probe readings during the electrolytic production of the metal;
the at least one probe being protected from corrosion by the conductor pin during electrolytic production of the metal.

According to a preferred embodiment, the one or more probe readings indicate a temperature inside of the conductor pin.

According to a preferred embodiment, the method further comprises converting the one or more probe readings into a temperature profile of the electrolytic bath based on a position of each of the at least one of the at least two electrodes.

According to a preferred embodiment, the method further comprises using the one or more probe readings as an input of a control system for controlling temperature of the electrolytic bath.

According to a preferred embodiment, the method further comprises calibrating the at least one probe prior to determining the temperature of the electrolytic bath.

According to a preferred embodiment, the one or more probe readings from the at least one probe are received periodically, and wherein determining the temperature of the electrolytic bath based on the one or more probe readings is repeated upon each reception of the one or more probe readings.

According to another aspect, the invention is further directed to an electrolytic cell for electrolytic production of a metal, the electrolytic cell comprising an electrolytic bath, and at least two electrodes wherein at least one of the at least two electrodes is an anode and one of the at least two electrodes is a cathode, at least one of the at least two electrodes comprises: an electrode body and a conductor pin at least partially inserted thereinto, the conductor pin providing electrical connection of the electrode; and at least one probe inserted into at least a corresponding one of the at least two conductor pins, each probe providing one or more probe readings and being operable when positioned at least partially below a bath-vapor interface upon immersion of the at least one of the at least two electrodes into the electrolytic bath; wherein the temperature of the bath is determined based on at least one of the one or more probe readings; and wherein the at least one probe is protected from corrosion by the corresponding one conductor pin during the electrolytic production of the metal.

According to a preferred embodiment the electrolytic cell further comprises a control system for controlling temperature of the electrolytic bath based on the one or more probe readings.

The invention is yet further directed to an electrolytic cell for electrolytic production of a metal, the electrolytic cell comprising an electrolytic bath, at least one anode assembly comprising a plurality of vertically aligned anodes configured to be plunged into the bath, and at least one cathode within the bath, wherein at least one of the anode of the anode assembly is the apparatus for measuring the temperature of the bath as defined herein.

According to a preferred embodiment more than one anode of the anode assembly consist in the apparatus for measuring the temperature of the bath, in order to evaluate a temperature profile in the bath.

According to a preferred embodiment, the one or more anodes are inert or oxygen evolving anodes, and the metal to be produced is aluminum.

The process or method according to the present invention is intended to be implemented by a computer, by means of a computer program consisting of instructions adapted to implement at least each of the steps of this process. The invention thus also relates to a computer program comprising instructions suitable for implementing each of the steps of the methods described above, when the program is executed on a computer.

The invention is particularly adapted for measuring the temperature of an electrolytic bath during its operation for the production of a metal, such as aluminum. Protecting the probe from corrosion by having the probe located within the conductor pin of the electrode allows extending the life time of the probe.

Other and further aspects and advantages of the present invention will be better understood upon the reading of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 is a schematic illustration of an apparatus for determining an electrolytic bath temperature of an electrolytic cell according to a preferred embodiment;

FIG. 2 is a flow chart of a method for determining an electrolytic bath temperature of an electrolytic cell according to a preferred embodiment;

FIG. 3 shows a logical modular representation of a system for determining temperature of an electrolytic bath in an electrolytic cell in accordance with the teachings of the present invention; and

FIG. 4 is a graphic showing an example of normalized temperature data versus time for direct measurements of the bath with a thermocouple compared to measurements of the same with the apparatus according to a preferred embodiment of the invention.

### DETAILED DESCRIPTION OF THE PREFERRED EMBODIMENT

Novel apparatuses and methods for measuring temperature of an electrolytic bath of an electrolytic cell will be described hereinafter.

The terminology used herein is in accordance with definitions set out below.

As used herein % or wt. % means weight % unless otherwise indicated. When used herein % refers to weight % as compared to the total weight percent of the phase or composition that is being discussed.

By “about”, it is meant that the value of weight % (wt. %), time, resistance, volume or temperature can vary within a certain range depending on the margin of error of the method or device used to evaluate such weight %, time, resistance, volume or temperature. A margin of error of 10% is generally accepted.

The description which follows, and the embodiments described therein are provided by way of illustration of an example of particular embodiments of principles and aspects of the present invention. These examples are provided for the purposes of explanation and not of limitation, of those principles of the invention. In the description that follows, like parts and/or steps are marked throughout the specification and the drawing with the same respective reference numerals or signs.

As previously mentioned, a major challenge arises when measuring the temperature of an electrolytic bath that is maintained at high temperatures (e.g., circa 900° C.) and is highly corrosive. In response to this challenge, one solution is to better protect the thermocouple to extend its life time in such an environment.

Disclosed herein is an apparatus for determining a temperature of an electrolytic bath of an electrolytic cell during electrolytic production of a metal. Preferably, the metal is aluminum. However, other metals produced by electrolysis can be considered within the scope of the technology disclosed herein.

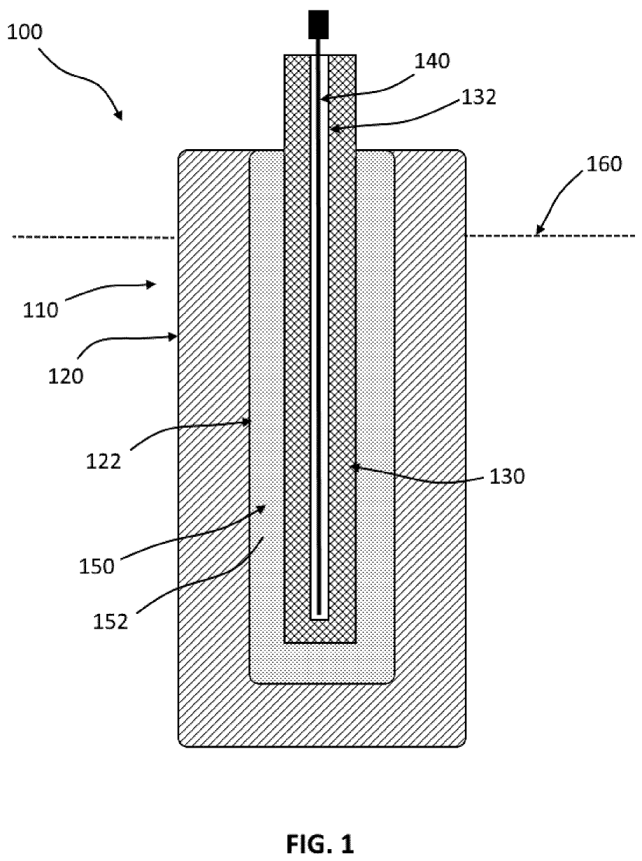

The apparatus 100, as the one illustrated on FIG. 1, comprises one electrode 110 having an electrode body 120 and a conductor pin 130 at least partially inserted thereinto.

According to a preferred embodiment, the electrode 110 disclosed herein may be a cathode. Cathodes of an electrolytic cell for the making of a metal, are electrically conductive, chemically resistant to the metal and the bath, and have good wettability for the produced metal. Cathodes may be for instance vertical plates of a given thickness presenting therefore two opposite flat surfaces for facing the adjacent anodes. Examples of electrode configurations are disclosed in U.S. Pat. No. 10,415,147 B2 (ELYSIS LIMITED PARTERSHIP), or PCT/CA2021/051689 (ELYSIS LIMITED PARTERSHIP) filed on Nov. 25, 2021, on the content of which is incorporated herein by reference.

According to another preferred embodiment, the electrode 110 disclosed herein may be an anode. The anodes in accordance with the present disclosure may be inert anodes or oxygen evolving anodes. Inert anodes can be made of single compounds, composite, or alloy-type materials. Examples of inert anodes include: ceramic, cermet, metal anodes, and any combination thereof. The anodes, in accordance with the present disclosure, comprise an anode body in which is inserted an anode pin for conducting the electricity. Examples of such anodes are provided in U.S. Pat. No. 9,945,041 B2 (Reed et al.) or European patent EP 3 161 187 (ELYSIS LIMITED PARTERSHIP), the content of which is incorporated herein by reference.

The conductor pin 130 as the one illustrated on FIG. 1, provides electrical connection of the electrode body 120. The conductor pin 130 may also be configured to mechanically support the electrode body 120. The conductor pin 130 may be partially or completely made of stainless steel, a nickel-based alloy such as Inconel®, cobalt, copper, and/or an alloy thereof. The conductor pin 130 is inserted into the electrode body 120 through an inner hole 122 extending inside the electrode body 120.

As shown in FIG. 1, the apparatus 100 may comprise a gap 150 formed between the conductor pin 130 and the electrode body 120, in order to case the insertion of the pin into the hole 122. The gap 150 may be filled up with one or more conductive materials or fillers 152. During manufacture of the electrode 110, a conductive material 152 is poured into the gap 150 once the conductor pin 130 is inserted into the hole 122 of the electrode body 120. The conductive material or filler 152 may be a conductive metal, such as copper, steel or nickel-based alloy, such as Inconel®.

As shown in FIG. 1, the apparatus 100 also comprises a probe 140, for providing one or more probe readings to measure, determine and/or evaluate the temperature of the electrolytic bath. The probe 140 is inserted into the conductor pin 130 in a way that the probe will be positioned at least partially below the bath-vapor interface 160 the electrode is plunged into the electrolytic bath, as schematized on FIG. 1. Accordingly, the probe 140 is protected from corrosion by the conductor pin 130 during the electrolytic production of the metal. Preferably, the probe 140 may be inserted into the conductor pin 130 through a bore 132 extending thereinside.

According to a preferred embodiment, the probe 140 is a thermocouple forming a longitudinal rod. A person skilled in the art may already recognize that the probe may be any device that allows for, at least, measuring a temperature.

As explained above, the probe 140 provides one or more probe readings allowing determination of the temperature of the electrolytic bath by heat transfer via convection and conduction from the bath inside the electrode body and the pin. The probe readings may indicate the temperature inside the conductor pin 130 and the temperature of the electrolytic bath may be determined therefrom.

According to a preferred embodiment, the probe 140 is calibrated or calculations are done to obtain a function that determines the temperature of the electrolytic cell based on the probe readings.

A person skilled in the art may already recognize that a plurality of probes may be inserted into one conductor pin. This configuration may allow for comparison of the probe readings provided by each probe of the same electrode. For instance, a probe can be found defective if there is a high discrepancy between the probe readings provided by this probe and the probe readings provided by the other probes of the same electrode. In this way, even though the probe reading of this probe is not accurate, the probe readings from the other probes of the electrode can still be used, therefore further extending the lifetime of the apparatus.

In yet another preferred embodiment, the apparatus may be comprised within an electrode assembly comprising a plurality of electrodes in which more than one probe are inserted in different conductor pins of the electrode assembly. In this configuration, a plurality of probe readings are simultaneously obtained and could be used to obtain a temperature profile of the conductor pins based on the different positions of the corresponding apparatuses 100. The probe readings can be, subsequently or alternatively, converted into a temperature profile of the electrolytic bath based on the position of the corresponding apparatuses 100.

According to a preferred embodiment, the probe 140 may provide a probe reading periodically. For instance, the probe 140 may be set to provide a probe reading every 10 minutes. This time-period between two probe readings of the same probe may be set up depending on different operation stages of the electrolytic cell. For instance, the time period may be shortened for monitoring the heating or cooling stage of the electrolytic bath.

According to another preferred embodiment, the one or more probes 140 may provide probe readings continuously, for continuously monitoring the temperature or the temperature profile of the bath.

An electrolytic cell is also disclosed for electrolytic production of a metal such as but not limited to aluminum. The electrolytic cell comprises an electrolytic bath of a molten electrolyte (such as cryolite) and at least two electrodes: an anode and a cathode, such as those already disclosed herein above. The electrolytic cell in accordance with the present disclosure comprises one or more anode assemblies, each of them comprising a plurality of vertical anodes, more preferably inert anodes or oxygen evolving anodes, such as those disclosed herein above. Reference can be made to the electrolytic cell with vertically oriented cathodes and anodes as disclosed in U.S. patent U.S. Pat. No. 10,415,147 B2 cited above.

At least one of the anodes of the anode assembly of the electrolytic cell will be replaced with the apparatus 100 for measuring the temperature as disclosed herein.

In yet another preferred embodiment, each anode assembly may comprises one or more probes, preferably more than one, each of the probes being calibrated to obtain a function that determines the temperature, more preferably a temperature profile, of the electrolytic bath based on the different probe readings.

According to a preferred embodiment, the electrolytic cell may be controlled by a control system, such as for controlling temperature of the electrolytic bath based on the probe readings. For instance, the control system maintains electrolytic bath temperature at desired optimally determined setpoint and accordingly may initiate increase or decrease of the temperature of the electrolytic cell if the temperature of the electrolytic bath is determined to be too low or too high.

It is further disclosed herein a method for determining a temperature of an electrolytic bath of an electrolytic cell during electrolytic production of a metal such as, but not limited to, aluminum. The electrolytic cell comprises an electrolytic bath of a molten electrolyte (such as cryolite) and at least two electrodes: an anode and a cathode. Preferably, the cell comprises one or more electrode assemblies comprising each a plurality of anodes or cathodes.

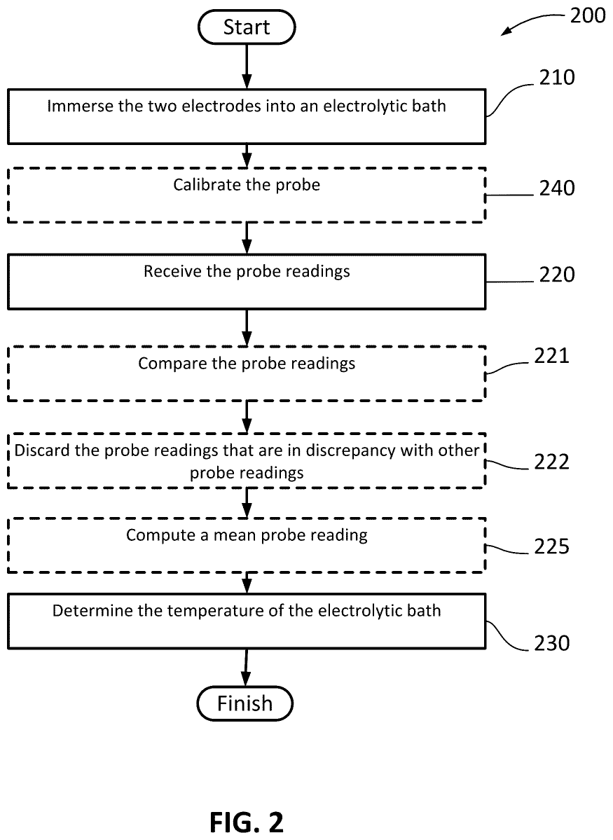

As described in FIG. 2, the method 200 comprises immersing 210 the two electrodes into the electrolytic bath. At least one of the electrodes comprises an electrode body and a conductor pin at least partially inserted into the electrode body. The conductor pin provides electrical connection of the electrode. The electrode body also comprises a probe that provides one or more probe readings allowing determination of the temperature of the electrolytic bath. The probe is inserted into the conductor pin and is to be positioned at least partially below the bath-vapor interface upon immersion 210 of the electrode into the electrolytic bath. In this configuration, the probe is protected by the conductor pin from corrosion during the electrolytic production of the metal.

The discussions held above concerning the anodes, the cathodes, the electrode body, the conductor pin, and the probe are still relevant and apply to the method 200.

The method 200 comprises receiving 220 the probe readings from the probe. The probe readings may be received 220 by a processor module of a control system configured to monitor temperature of the electrolytic cell. The probe readings may indicate the temperature inside the conductor pin.

The method 200 also comprises determining 230 the temperature of the electrolytic bath based on the one or more probe readings.

In some embodiments, the temperature of the electrolytic bath may be determined 230 by adding or subtracting a constant value to the probe reading.

Therefore, the method 200 may further comprise calibrating 240 the probe to obtain a function that determines the temperature of the electrolytic cell based on the probe readings, prior to receiving 220 the probe readings.

In the example where the probe periodically provides a probe reading, the method 200 may be performed every time the probe provides a new probe reading and as long as the electrode is in service.

In the example where the probe provides probe readings in a continuous way, the method 200 may be performed in a continuous way (i.e., each time the probe provides a new probe reading) as long as the electrode is in service.

When a plurality of probes are inserted into one conductor pin for instance, the method 220 may further comprise, prior to determining 230 the temperature of the electrolytic bath, computing 225 a mean probe reading based on the probe readings of the probes inserted into the same conductor pin and using the mean probe reading to determine 230 the temperature of the electrolytic bath.

In this example, the method 200 may further comprise, prior to computing 225 the mean probe reading, comparing 221 the probe readings of the probes inserted into the same conductor pin. The probe readings that are in discrepancy with the other probe readings may be discarded 222 prior to computing 225 the mean probe reading. For instance, probes reading can be significantly different beyond thermocouple accuracy range may be called outliers and discarded. Thermocouple accuracy (e.g. +/−1-2%) may be used to define discrepancy.

When the electrolytic cell comprises an anode assembly, for instance with a plurality of vertically oriented anodes, the method 200 allows obtaining 250 a temperature profile of the conductor pins and/or bath based on the position of the corresponding apparatuses 100 within the anode assembly and the bath.

Although vertically oriented anodes or cathodes are disclosed herein, the inventive concept of having the probe or thermocouple directly inserted in the electrical conductive pin of the electrode can also be applied to other orientations of electrodes without departing from the scope of the present invention.

According to another aspect, the invention also relates to a computer program comprising instructions suitable for implementing each of the steps of the methods described herein, when the program is executed on a computer.

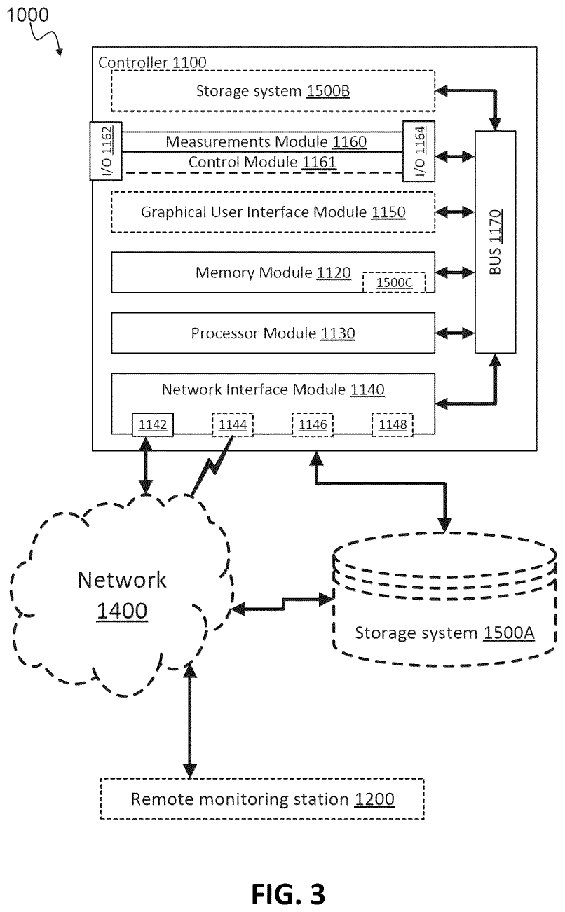

FIG. 3 shows a logical modular representation of a system 1000 for determining the temperature or the temperature profile of an electrolytic bath in an electrolytic cell and, in certain embodiments, controlling the temperature, in accordance with the teachings of the present application. As previously discussed, the electrolytic cell comprises at least one anode assembly of one or more anodes, at least one cathode, an electrolytic bath, and a current supply buss providing a current to the at least one anode assembly through a distinct anode pin for each anode assembly. The system 1000 provides an exemplary modular view of the controller 1100 involved in the determination. The system 1000 may also comprise a remote monitoring station 1200.

In some embodiments, the controller 1100 may exchange data with the remote monitoring station 1200 and the controller 1100 is therefore able to exchange one or more message and/or one or more commands with the remote monitoring station 1200.

In the depicted example of FIG. 3, the controller 1100 comprises a memory module 1120, a processor module 1130 and a network interface module 1140.

The processor module 1130 may represent a single processor with one or more processor cores or an array of processors, each comprising one or more processor cores.

The memory module 1120 may comprise various types of memory (different standardized or kinds of Random Access Memory (RAM) modules, memory cards, Read-Only Memory (ROM) modules, programmable ROM, etc.). The network interface module 1140 represents at least one physical interface that can be used to communicate with other network nodes. The network interface module 1140 may be made visible to the other modules of the controller 1100 through one or more logical interfaces. The actual stacks of protocols used by the physical network interface(s) and/or logical network interface(s) 1142, 1144, 1146, 1148 of the network interface module 1140 do not affect the teachings of the present application. The variants of processor module 1130, memory module 1120 and network interface module 1140 usable in the context of the present application will be readily apparent to persons skilled in the art.

A bus 1170 is depicted as an example of means for exchanging data between the different modules of the controller 1100. The present invention is not affected by the way the different modules exchange information between them. For instance, the memory module 1120 and the processor module 1130 could be connected by a parallel bus, but could also be connected by a serial connection or involve an intermediate module (not shown) without affecting the teachings of the present invention.

Likewise, even though explicit mentions of the memory module 1120 and/or the processor module 1130 are not made throughout the description of the various embodiments, persons skilled in the art will readily recognize that such modules are used in conjunction with other modules of the controller 1100 to perform routine as well as innovative steps related to the present invention.

The controller 1100 may also comprise an optional Graphical User Interface (GUI) module 1150 comprising one or more display screen(s) forming a display system, for the controller 1100. The display screens of the GUI module 1150 could be split into one or more flat panels, but could also be a single flat or curved screen visible from an expected user position (not shown). Skilled persons will readily understand that the GUI module 1150 may be used in a variety of contexts not limited to the previously mentioned examples.

The system 1000 may comprise a data storage system 1500 that comprises data related to brick positioning and may further log data while the production is performed. FIG. 3 shows examples of the storage system 1500 as a distinct database system 1500A, a distinct module 1500B of the controller 1100 or a sub-module 1500C of the memory module 1120 of the controller 1100. The storage system 1500 may also comprise storage modules (not shown) on the remote monitoring station 1200. The storage system 1500 may be distributed over different systems A, B, C and/or the remote monitoring station 1200 or may be in a single system. The storage system 1500 may comprise one or more logical or physical as well as local or remote hard disk drive (HDD) (or an array thereof). The storage system 1500 may further comprise a local or remote database made accessible to the controller 1100 by a standardized or proprietary interface or via the network interface module 1140. The variants of the storage system 1500 usable in the context of the present invention will be readily apparent to persons skilled in the art.

A measurement input module 1160 and an optional control module 1161 are provided in the controller 1100. The measurement input module 1160 and the control module 1161 will be referred to hereinbelow as distinct logical modules, but skilled person will readily recognize that a single logical module may have been shown instead.

In some embodiment, an optional external input/output (I/O) module 1162 and/or an optional internal input/output (I/O) module 1164 may be provided with the measurement input module 1160 and the control module 1161. The external I/O module 1162 may be required, for instance, for interfacing with one or more robots, one or more input device (e.g., measurement probe) and/or one or more output device (e.g., printer).

The internal input/output (I/O) module 1164 may be required, for instance, for interfacing the controller 1100 with one or more instruments or controls (not shown) typically used in the context of electrolysis cell control (e.g., probes). The I/O module 1164 may comprise necessary interface(s) to exchange data, set data or get data from such instruments or controls.

The measurement input module 1160 and processor module 1130 are tightly related to the detection of the thermite reaction. In the example of the system 1000, the measurement input module 1160 and the processor module 1130 may be involved in various step of a method 200 described hereinabove.

### EXAMPLES

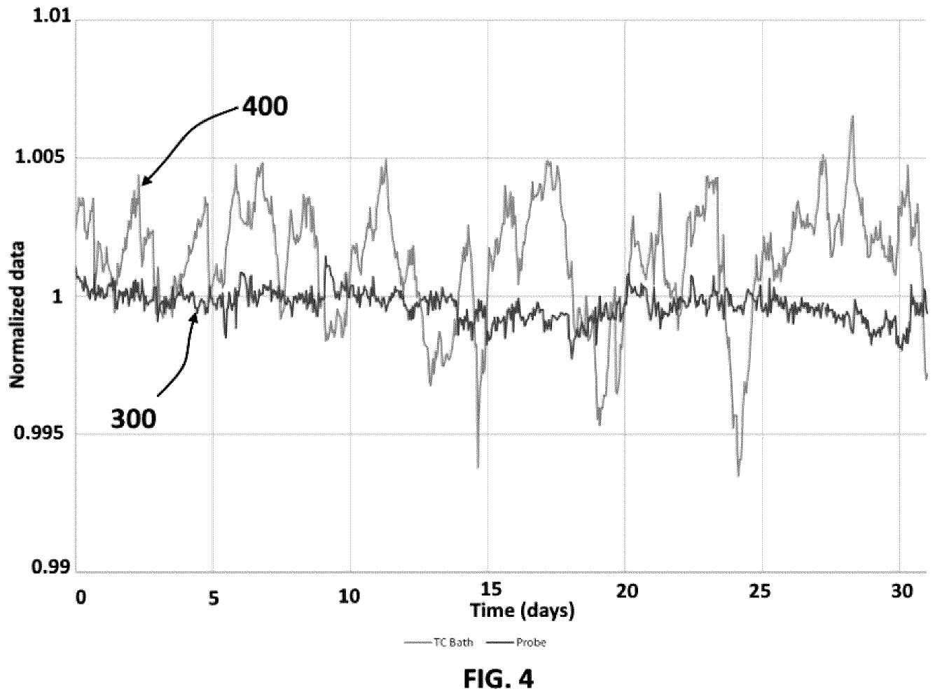

FIG. 4 is an example of measurements of normalized temperature data versus time (in days) of the electrolytic bath. The data related to the direct measurements of the bath temperature with a thermocouple 400 (TC Bath), are compared with the measurements of the bath temperature with the probe within an electrode 300 (Probe) according to a preferred embodiment of the invention. The line 300 shows that the temperature recorded with the invention has less than 0.25% difference from the temperature 400 recorded directly from the bath.

The present apparatus and method for determining the temperature of an electrolytic bath of an electrolytic cell, allow extending the lifetime of the probe by inserting the probe, such as a thermocouple, directly inside the conductor pin of an electrode, preferably an anode, and therefore protecting the probe from corrosion as long as the conductor pin remains intact. Also, the apparatus and method as disclosed herein allow: minimizing costs and maintenance labor compared to known method for measuring bath temperature; minimizing process control interruptions caused by the defective probes; minimizing contamination of the bath by ceramic protection tubes used in the past; and improving accuracy of the temperature measurement of the electrolytic bath as the probe can be immersed deeply into the electrolytic bath and avoiding the heat sink caused by the known bulky material protection. Furthermore, the possibility of using several embedded probes according to the present invention in one electrode assembly allows providing more data (e.g. up to 17/assembly or more) and thus average data calculated thereform. These data are more stable and more relevant than a single thermocouple used somewhere in the bath.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. An apparatus for determining a temperature of an electrolytic bath of an electrolytic cell during electrolytic production of a metal, the apparatus comprising:
an electrode body;
a conductor pin at least partially inserted in the electrode body for providing electrical connection to the electrode body; and
a probe configured to be inserted in the conductor pin and to measure an inner temperature of the conductor pin, the probe providing one or more probe readings and being operable when positioned at least partially below a bath-vapor interface upon immersion of the electrode body in the electrolytic bath;
wherein the temperature of the electrolytic bath is determined based on at least one of the one or more probe readings; and
whereby, in use, the probe is protected from corrosion by at least the conductor pin during the electrolytic production of the metal.

2. The apparatus of claim 1, wherein the conductor pin is inserted into the electrode body through an inner hole extending thereinside.

3. The apparatus of claim 1, wherein the probe is inserted into the conductor pin through a bore extending thereinside.

4. The apparatus of claim 1, further comprising a gap formed between the conductor pin and the electrode body, the gap being configured for containing a conductive material.

5. The apparatus of claim 1, wherein the at least one probe is a thermocouple.

6. The apparatus of claim 1, wherein the electrode body and the conductive pin form an inert or oxygen evolving anode.

7. The apparatus of claim 1, wherein the metal to be produced is aluminum.

8. A method for determining a temperature of an electrolytic bath of an electrolytic cell during electrolytic production of a metal, the electrolytic cell comprising an electrolytic bath and at least two electrodes, the method comprising:
immersing the at least two electrodes into the electrolytic bath, wherein at least one of the at least two electrodes is an apparatus for determining the temperature of the electrolytic bath comprising:
an electrode body,
a conductor pin at least partially inserted thereinto for providing electrical connection to the electrode body, and
a probe inserted in the conductor pin, the probe being configured for providing one or more probe readings of an inner temperature of the conductor pin, wherein at least a portion of the probe is positioned below a bath-vapor interface;
receiving the one or more probe readings from the probe; and
determining the temperature of the electrolytic bath based on the one or more probe readings during the electrolytic production of the metal;
the probe being protected from corrosion by at least the conductor pin during electrolytic production of the metal.

9. The method of claim 8, wherein the electrolytic cell comprises a plurality of electrodes among which more than one electrode is an apparatus for determining the temperature of the electrolytic bath, the method comprising receiving one or more probe readings from each of the apparatuses for determining the bath temperature.

10. The method of claim 9, further comprising converting the one or more probe readings into a temperature profile of the electrolytic bath based on a position of each of each of the apparatuses for determining the bath temperature.

11. The method of claim 8, further comprising using the one or more probe readings as an input of a control system for controlling temperature of the electrolytic bath.

12. The method of claim 8, further comprising calibrating the probe prior to determining the temperature of the electrolytic bath.

13. The method of claim 8, wherein the one or more probe readings from the probe are received periodically, and wherein determining the temperature of the electrolytic bath based on the one or more probe readings is repeated upon each reception of the one or more probe readings.

14. An electrolytic cell for electrolytic production of a metal, the electrolytic cell comprising an electrolytic bath, at least one anode assembly comprising a plurality of vertically aligned anodes configured to be plunged into the electrolytic bath, and at least one cathode within the bath, wherein at least one of the anode of the anode assembly is the apparatus for measuring the temperature of the bath as defined in claim 1.

15. The electrolytic cell of claim 14, wherein more than one anode of the anode assembly consist in the apparatus for measuring the temperature of the bath, in order to evaluate a temperature profile in the bath.

16. The electrolytic cell of claim 14, wherein the one or more anodes are inert or oxygen evolving anodes, and the metal to be produced is aluminum.
